(19) United States
(12) Patent Application Publication
(10) Pub. No.: US 2008/0063440 A1
(43) Pub. Date: Mar. 13, 2008

(54) IMAGE FORMING APPARATUS AND METHOD

(75) Inventor: Ji-won MOON, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/627,533

(22) Filed: Jan. 26, 2007

(30) Foreign Application Priority Data
Sep. 12, 2006 (KR) 2006-88183

(51) Int. Cl. G03G 15/08

(52) U.S. Cl. 399/288

(57) ABSTRACT

An image forming method and apparatus to form visible images on a printing medium. The image forming apparatus includes a photosensitive medium on which electrostatic latent images are formed, and a toner-conveying member configured to follow an endless loop apart from the photosensitive medium to convey toner to the photosensitive medium. The image forming apparatus may include a non-contact developing unit.

### CROSS-REFERENCE TO RELATED APPLICATIONS

This application claims priority under 35 U.S.C. § 119(a) from Korean Patent Application No. 2006-88183 filed Sep. 12, 2006, in the Korean Intellectual Property Office, the disclosure of which is incorporated herein by reference in its entirety.

### BACKGROUND OF THE INVENTION

1. Field of the Invention

The present general inventive concept relates to an image forming apparatus and method. More particularly, the present general inventive concept relates to a non-contact developing type image forming apparatus and method.

2. Description of the Related Art

Generally electro photographic image forming apparatuses form electrostatic latent images on a photosensitive medium, develop the electrostatic latent images using toner, and transfer the images onto a printing medium, and include laser printers, facsimile machines, copiers, composite apparatuses of these (e.g. multifunction peripherals), etc.

An electro photographic image forming apparatus includes a printing medium feeding unit to supply printing media such as sheets of paper, an image forming unit to form images corresponding to printing data on a feeding printing medium, a fixing unit to fix the images formed at the image forming unit onto the printing medium and a discharging unit to discharge the printing medium having the printed image to an outside thereof.

The image forming unit includes a photosensitive medium, an exposure unit that scans laser beam corresponding to printing data so as to form predetermined electrostatic latent images on the photosensitive medium, a developing unit to develop the electrostatic latent images on the photosensitive medium into visible images, and a transferring roller to transfer the visible images on the photosensitive medium onto a printing medium.

The developing unit supplies the photosensitive medium with toner to develop the electrostatic latent images and includes a toner receptacle holding a predetermined amount of the toner, a developing roller that is disposed apart from the photosensitive medium and supplies the toner held in the toner receptacle to the photosensitive medium, and a doctor blade regulating the toner conveyed by the developing roller into a thin layer.

Upon receiving a printing order, the printing medium feeding unit picks up a printing medium and feeds it to the image forming unit. The exposure unit scans a laser beam so as to form the electrostatic latent images corresponding to received printing data on the photosensitive medium. When the photosensitive medium rotates so that the electrostatic latent images move into a developing area and faces the developing unit, the toner supplied by the developing roller of the developing unit develops the electrostatic latent images into visible images.

When the photosensitive medium continues to rotate, the visible images are transferred onto the printing medium fed from the printing medium feeding unit by the transferring roller. The images transferred onto the printing medium are fixed on the printing medium by the fixing unit as they pass by the fixing unit. Then, the printing medium having the fixed images thereon is discharged out of the image forming apparatus by the discharging unit.

At this time, to achieve good quality images in a non-contact developing type image forming apparatus, uniformity of a remaining developing gap, namely, a gap between the developing roller and the photosensitive medium, is important. However, in the conventional image forming apparatus, because various forces such as a force driving the developing roller, a force rotating an agitator, a force applied by the doctor blade, etc. are applied to the developing unit, there is a problem that maintaining uniformity of the gap remaining between the developing roller and the photosensitive medium is very difficult.

During printing, a change or non-uniformity of the remaining developing gap between the developing roller and the photosensitive medium due to the forces applied to the developing unit causes image deficiencies such as jitter, missing images, etc.

Also, in the conventional image forming apparatus, in order to maintain uniformity of the developing gap between the developing roller and the photosensitive medium, the developing roller is made of stiff and hard material. However, a hard developing roller gives the toner stress when the doctor blade regulates the toner conveyed on the developing roller into a thin layer. Some of the toner receives stress when the doctor blade regulating the toner is not conveyed to the developing area but remains in the toner receptacle. The stressed toner remaining in the toner receptacle is conveyed to the doctor blade with the toner having no stress in the toner receptacle and is regulated again by the doctor blade, thereby receiving more stress. When the electrostatic latent images are developed by the toner which receives too much stress due to several regulations of the doctor blade, the developed image quality is poor. As a result, the conventional image forming apparatus cannot use the toner of the toner receptacle until the toner receptacle is determined to have “run out” of toner. In other words, there is a problem that a life span of the toner is shortened.

### SUMMARY OF THE INVENTION

The present general inventive concept has been developed in order to overcome the above drawbacks and other problems associated with the conventional arrangement. The present general inventive concept provides an image forming apparatus to form good quality images by maintaining a uniform developing gap.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an image forming apparatus, which includes a photosensitive medium on which electrostatic latent images are formed, and a toner-conveying member configured to follow an endless loop apart from the photosensitive medium to convey toner to the photosensitive medium.

The image forming apparatus may further include a doctor blade to regulate the toner conveyed by the toner-conveying member into a thin toner layer and to charge the toner

The image forming apparatus may further include at least two developing rollers disposed inside the toner-conveying member to drive and support the toner-conveying member to follow an endless loop and a power source to apply voltage to at least one of the at least two developing rollers.

The at least two developing rollers may include a first developing roller disposed nearby the photosensitive medium, and a second developing roller disposed underneath a part of the toner-conveying member in contact with the doctor blade to drive the toner-conveying member.

The first developing roller may be made of a stiff material not to be bent by a force that the toner-conveying member applies and the second developing roller may have a hardness to minimize a stress of the toner when the doctor blade regulates the toner into a thin layer.

The first developing roller may further include a pair of gap rings having an outer diameter larger than an outer diameter of the first developing roller and disposed coaxially at both ends of the first developing roller.

The image forming apparatus may further include a toner receptacle holding the toner, at which the second developing roller and the doctor blade are disposed, and a supplying roller disposed to be in contact with the toner-conveying member inside the toner receptacle to supply the toner held in the toner receptacle to the toner-conveying member.

The image forming apparatus may further include an elastic member to elastically support the toner receptacle in a direction opposite to the photosensitive medium and a to press member pressing the first developing roller to the photosensitive medium for the pair of gap rings to continue to be in contact with the photosensitive medium.

The a least two developing rollers may include a first developing roller disposed nearby the photosensitive medium, a second developing roller disposed underneath a part of the toner-conveying member in contact with the doctor blade to drive the toner-conveying member, and a third developing roller disposed apart from the photosensitive medium under the first developing roller by a same gap as a gap between the first developing roller and the photosensitive medium.

The image forming apparatus may further include a toner scatter preventing member disposed under a developing area between the photosensitive medium and the toner-conveying member apart from the photosensitive medium to rotate in a same direction as a rotation direction of the photosensitive medium.

A gap between the toner scatter preventing member and the photosensitive medium may be 1.5 mm or less.

The toner scatter preventing member is rotatably disposed at an inner frame, and the inner frame has a plurality of air holes.

The foregoing and/or other aspects and utilities of the present general inventive concept may also be achieved by providing an image forming apparatus including a first image forming part including a photosensitive medium on which electrostatic latent images are formed, toner-conveying member configured to follow an endless loop at a predetermined distance apart from the photosensitive medium to convey toner to the photosensitive medium, and a first developing roller disposed a predetermined distance from the photosensitive medium to support the toner-conveying member; and a second image forming part including a second developing roller to drive and support the toner-conveying member, and a developing unit to provide toner to the toner-conveying member such that the toner transfers from the toner-conveying member to the photosensitive medium at the predetermined distance.

The foregoing and/or other aspects and utilities of the present general inventive concept are achieved by providing a method of forming an image with an image forming apparatus, the method including supplying toner from a developing unit to a toner-conveying member which surrounds first and second rollers in an endless loop, conveying toner to a photosensitive member via the toner-conveying member, driving the toner-conveying member with the second roller and supporting the toner-conveying member a predetermined distance from the photosensitive member with the first roller such that the toner-conveying member is supported by the first and second roller.

Other objects, advantages and salient features of the present general inventive concept will become apparent from the following detailed description, which, taken in conjunction with the annexed drawings, discloses preferred embodiments of the present general inventive concept.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a sectional view schematically illustrating an image forming apparatus according to an embodiment of the present general inventive concept;

FIG. 2 is an enlarged sectional view illustrating an embodiment of a developing unit and a photosensitive unit of the image forming apparatus of FIG. 1;

FIG. 3 is an enlarged sectional view illustrating another embodiment of a developing unit and a photosensitive unit of the image forming apparatus of FIG. 1;

FIG. 4 is an enlarged sectional view illustrating another embodiment of a developing unit and a photosensitive unit of the image forming apparatus of FIG. 1;

FIG. 5 is an enlarged sectional view illustrating another embodiment of a developing unit and a photosensitive unit, and a transferring roller of the image forming apparatus of FIG. 1; and

FIG. 6 is an enlarged sectional view illustrating another embodiment of a developing unit and a photosensitive unit of the image forming apparatus of FIG. 1.

Throughout the drawings, like reference numerals will be understood to refer to like parts, components and structures.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as a detailed construction and elements thereof, are provided to assist in a comprehensive understanding of the present general inventive concept. Thus, it is apparent that the present general inventive concept may be carried out without those defined matters. Also, well-known functions or constructions are omitted to provide a clear and concise description of exemplary embodiments of the present general inventive concept.

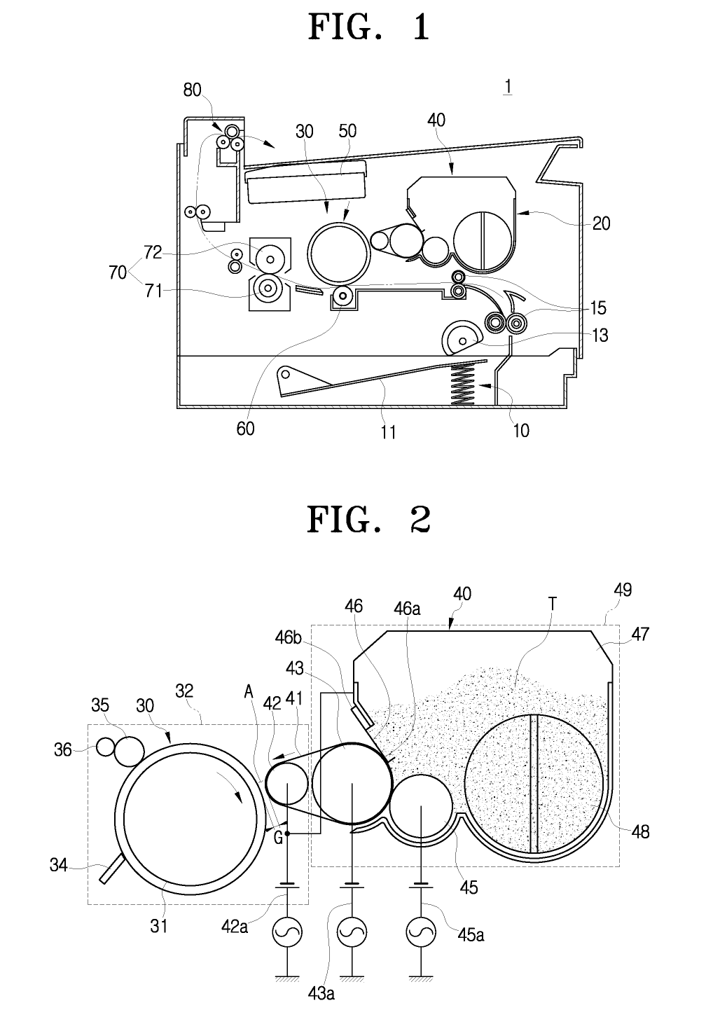

Referring to FIG. 1, an image forming apparatus 1 according to an embodiment of the present general inventive concept includes a printing medium feeding unit 10, an image forming unit 20, a fixing unit 70, and a discharging unit 80.

The printing medium feeding unit 10 holds printing media and picks up printing media one by one to feed it to the image forming unit 20. The printing medium feeding unit 10 includes a printing medium cassette 11 loaded with a lot of printing media and a pickup roller 13 that is disposed above the printing medium cassette 11 and picks up an uppermost printing medium one by one. A plurality of feeding rollers 15 is disposed between the printing medium feeding unit 10 and the image forming unit 20, and feeds a printing medium picked up by the pickup roller 13 to the image forming unit 20.

The image forming unit 20 forms images corresponding to printing data, and then, transfers the images onto a printing medium which is fed from the printing medium feeding unit 10, and includes a photosensitive unit 30, an exposure unit 50, a developing unit 40, and a transferring roller 60.

Referring to FIG. 2, the photosensitive unit 30 includes a photosensitive medium 31 that is rotatably disposed and is exposed by a laser beam, a cleaning blade 34 to clean toner T remaining on the photosensitive medium 31, a charging member 35 to charge the photosensitive medium 31, and a cleaning roller 36 to clean foreign materials from a surface of the charging member 35.

The exposure unit 50 scans the laser beam corresponding to the printing data so as to form predetermined electrostatic latent images on the photosensitive medium 31.

The developing unit 40 develops the electrostatic latent images on the photosensitive medium 31 into visible images, and includes a toner-conveying member 41, a doctor blade 46, and a toner receptacle 47.

The toner-conveying member 41 may be substantially a type of film, and disposed so that it follows an endless loop to convey the toner T held in the toner receptacle 47 to a developing area A. The toner T conveyed to the developing area A is moved onto the photosensitive medium 31 by an electrical force so as to develop the electrostatic latent images. Here, the developing area A refers to an area where the photosensitive medium 31 and the toner-conveying member 41 face each other

Also, the toner-conveying member 41 rotates in a direction opposite to a rotation direction of the photosensitive medium 31. In other words, when the photosensitive medium 31 rotates in a clockwise direction, the toner-conveying member 41 rotates in a counter-clockwise direction. Preferably, a moving speed of the toner-conveying member 41 is faster than a rotation speed of the photosensitive medium 31 so that enough toner T can move to the photosensitive medium 31. In other words, the moving speed of the toner-conveying member 41 may be 1.0 to 1.6 times the rotation speed of the photosensitive medium 31.

At least two developing rollers 42 and 43 are disposed inside the toner-conveying member 41 so that the toner-conveying member 41 can follow an endless loop. In this embodiment, as illustrated in FIG. 2, two developing rollers 42 and 43 are disposed inside the toner-conveying member 41. A first developing roller 42 is disposed near the photosensitive medium 31, and a second developing roller 43 is further away from the photosensitive medium 31 than the first developing roller 42.

The second developing roller 43 functions as a drive roller so that the toner-conveying member 41 can follow an endless loop by the first and second developing rollers 42 and 43. Also, the second developing roller 43 supports the toner-conveying member 41 so that the doctor blade 46 can regulate the toner T being conveyed by the toner-conveying member 41 into a thin toner layer. The second developing roller 43 may be made of a soft material (namely, a material having a low hardness) so that when the doctor blade 46 regulates the toner T, a stress of the toner T is minimized and a nip between the doctor blade 46 and the toner-conveying member 41 is increased. If the second developing roller 43 has a JIS-A hardness of 50 or less, the stress of the toner T caused by the doctor blade 46 is minimized and the nip is increased.

Furthermore, the first developing roller 42 is a driven roller rotated by the toner-conveying member 41. The first developing roller 42 forces the toner-conveying member 41 to maintain the gap to the photosensitive medium 31 uniformly, and may be made of a stiff material not to be bent by a force that the toner-conveying member 41 applies. For example, the first developing roller 42 may be made of any of stainless steel (SUS), metal alloy (SUM), aluminum (Al), etc. The first developing roller 42 may have a JIS-A hardness of 50 or more. Alternately, the first developing roller 42 may be a fixed roller which does not rotate. Then, when the second developing roller 43 rotates, the toner-conveying member 41 rotates and slides along on a surface of the first developing roller 42. Furthermore, the first developing roller 42 according to this embodiment has a roller shape; however this should not be considered as limiting. The first developing roller 42 can have various suitable shapes which support the toner-conveying member 41 to follow an endless loop.

On the other hand, the first and second developing rollers 42 and 43, respectively, are fixed to separate members. In other words, the second developing roller 43 is fixed to a second fixing member 49 to which the developing unit 40 is fixed, and the first developing roller 42 is fixed to a first image forming part 32 to which the photosensitive unit 30 is fixed. Therefore, a force applied to the developing unit 40 does not directly transmit to the first developing roller 42 but indirectly transmits to the first developing roller 42 via the toner-conveying member 41. As a result, the developing gap G between the photosensitive medium 31 and the toner-conveying member 41 is not affected by the force applied to the developing unit 40 so as to be maintained constantly.

The doctor blade 46 regulates a thickness of the toner T conveyed on the toner-conveying member 41 so that the toner T is formed in a thin toner layer. Also, when the toner T passes underneath the doctor blade 46, the toner T is charged by a friction force. The doctor blade 46 may be fixed to the toner receptacle 47 above the second developing roller 43.

There may be two methods in which the doctor blade 46 is disposed with respect to the toner-conveying member 41. One method is that the doctor blade 46 is disposed to be upwardly inclined in a rotation direction of the toner-conveying member 41, namely, in a leading method, as illustrated in FIG. 2. In other words, a rear end 46b of the doctor blade 46 is located in front of a front end 46a of the doctor blade 46 in the rotation direction of the toner-conveying member 41. The front end 46a of the doctor blade 46 is in contact with a part of the toner-conveying member 41 on the second developing roller 43, and the rear end 46b of the doctor blade 46 is separate or apart from the toner-conveying member 41. The other method (not illustrated) is that the doctor blade 46 is disposed to be downwardly inclined in the rotation direction of the toner-conveying member 41, namely, in a trail method. In other words, the front end 46a of the doctor blade 46 is located in front of the rear end 46b of the doctor blade 46 in the rotation direction of the toner-conveying member 41. The front end 46a of the doctor blade 46 is in contact with a part of the toner-conveying member 41 on the second developing roller 43, and the rear end 46b of the doctor blade 46 is separate or apart from the toner-conveying member 41.

The toner receptacle 47 holds the toner T, and supports the second developing roller 43 to rotate. A supplying roller 45 to supply the toner T to the toner-conveying member 41 rotated by the second developing roller 43 may be disposed inside the toner receptacle 47. Also, an agitator 48 that agitates the toner T in the toner receptacle 47 to prevent the toner from solidifying (i.e. from becoming solid) may be disposed inside the toner receptacle 47.

Reference numerals 42a, 43a, and 45a, respectively, represent power sources to apply a voltage to each of the first developing roller 42, the second developing roller 43, and the supplying roller 45. The developing unit 40 according to this embodiment is configured for the voltage to be applied to both of the first and second developing rollers 42 and 43. Alternately, the developing unit 40 may be configured for the voltage to be only applied to any of the first developing roller 42 or the second developing roller 43.

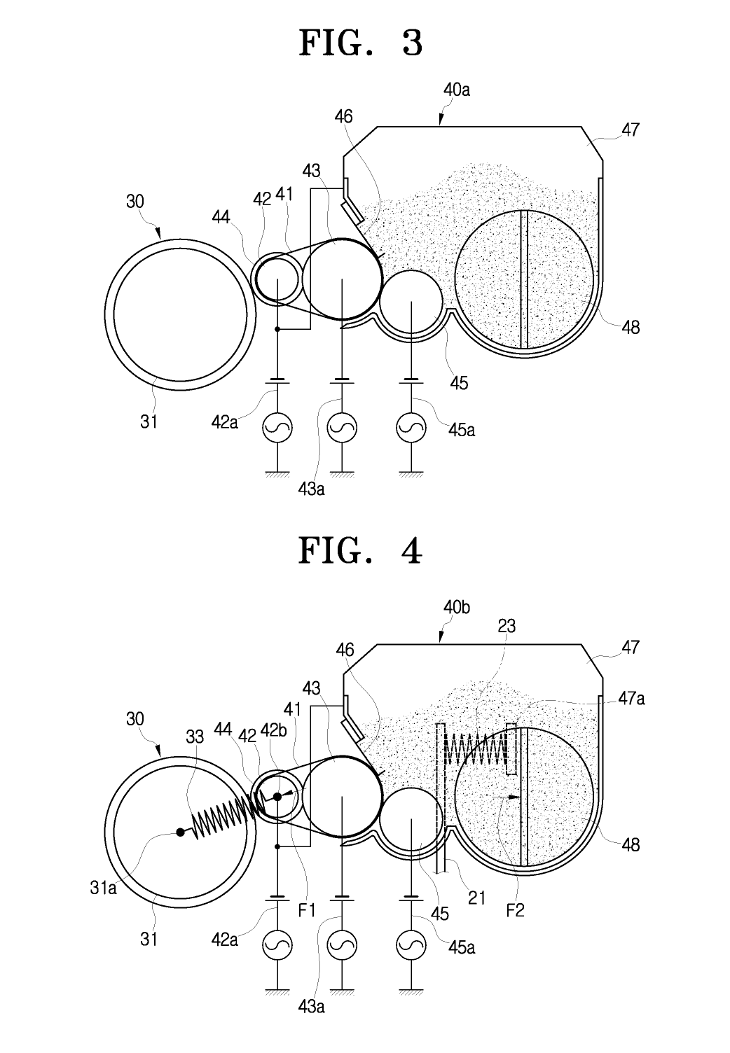

FIG. 3 is an enlarged sectional view illustrating another embodiment of a developing unit and a photosensitive unit used in an image forming apparatus 1 according to the present general inventive concept.

Referring to FIG. 3, the developing unit 40a according to this embodiment includes a pair of gap rings 44 that is disposed coaxially with the first developing roller 42 at both ends of the first developing roller 42, and maintains uniformity of the gap between the photosensitive medium 31 and the first developing roller 42. The pair of gap rings 44 has an outside diameter larger than an outside diameter of the first developing roller 42. At this time, the outside diameter of the gap rings 44 may be determined using a following formula:

D=(R1+T+G)×2

where, D is the outside diameter of the gap rings 44, R1 is a radius of the first developing roller 42, T is a thickness of the toner-conveying member 41, and G is a developing gap, namely a gap between the photosensitive medium 31 and the toner-conveying member 41.

Therefore, when the pair of gap rings 44 is disposed to be in contact with the photosensitive medium 31, the gap between the photosensitive medium 31 and the first developing roller 42 is maintained constantly. As a result, the developing gap G between the photosensitive medium 31 and the toner-conveying member 41 is also maintained constantly.

The remaining structure of the developing unit 40a according to this embodiment is substantially the same as the developing unit 40 of the t embodiment previously described above except for the pair of gap rings 44 disposed at the first developing roller 42, thus a detailed description thereof is omitted.

FIG. 4 is an enlarged sectional view illustrating another embodiment of a developing unit and a photosensitive unit used in an image forming apparatus 1 according to the present general inventive concept.

Referring to FIG. 4, a developing unit 40b according to this embodiment of the present inventive concept includes elastic members 23, and a photosensitive unit 30 includes pressing members 33. The elastic members 23 are disposed at both sides of the toner receptacle 47, and elastically support the developing unit 40b to come apart from the photosensitive medium 31. In other words, the elastic members 23 are disposed to elastically support the developing unit 40b in a direction F2 opposite to the photosensitive medium 31. In this embodiment, compressive springs are used as the elastic members 23, and the compressive springs are disposed between a frame 21 of the image forming apparatus 1 and a supporting part 47a of the toner receptacle 47.

On the other hand, the pressing member 33 pulls the first developing roller 42 to the photosensitive medium 31 as arrow F2 in FIG. 4, so that the pair of gap rings 44 continues to be in contact with the photosensitive medium 31. In this embodiment, tension springs are used as the pressing members 33, and the tension springs are disposed between both ends of a shaft 31a of the photosensitive medium 31 and both ends of a shaft 42b of the first developing roller 42. Each of the first and second developing rollers 42 and 43 receives a force applied by each of the pressing members 33 and the elastic members 23 in a direction such that the first and second developing rollers 42 and 43 are forced away from each other, so that the toner-conveying member 41, disposed to wrap around the first and second developing rollers 42 and 43, can always maintain a predetermined tension force. Therefore, when some forces caused by a driving of the second developing roller 43, a driving of the agitator 48, or the weight of the developing unit 40b, etc. are applied to the developing unit 40b, the toner-conveying member 41 can maintain the predetermined tension force so as to become taught.

The remaining structure of the developing unit 40b according to this embodiment is substantially the same as the developing unit 40a of the previous embodiment described above except for the elastic members 23 and the pressing members 33, so that a detailed description thereof is omitted.

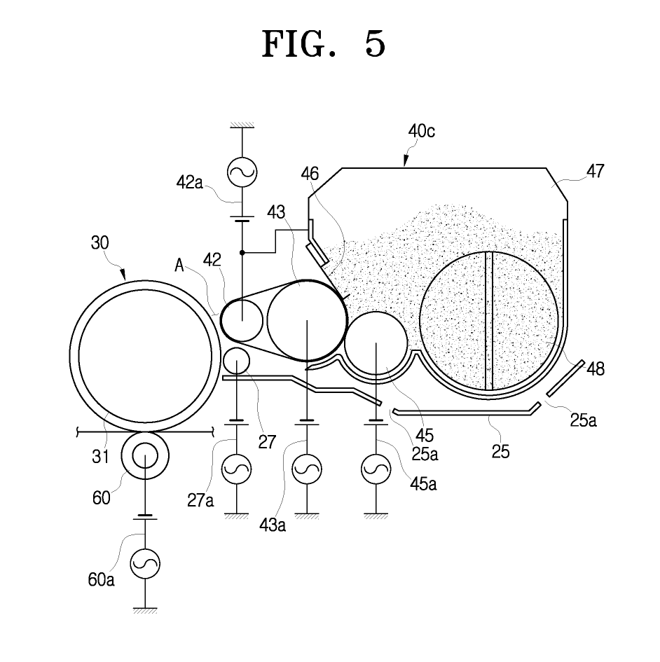

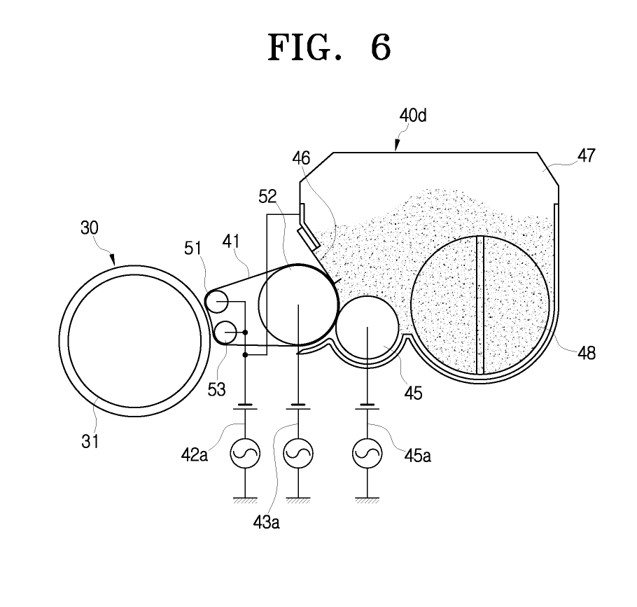

FIG. 5 is an enlarged sectional view illustrating another embodiment of a developing unit, a photosensitive unit, and a transferring roller used in an image forming apparatus 1 according to the present general inventive concept.

Referring to FIG. 5, a developing unit 40c according to this embodiment includes a toner scatter preventing member 27.

The toner scatter preventing member 27 is disposed below the first developing roller 42 apart from the photosensitive medium 31 under the developing area A. The toner scatter preventing member 27 may be formed in a roller shape, and can rotate in the same direction as the rotation direction of the photosensitive medium 31. Then, the toner scatter preventing member 27 generates an upward air current, thereby preventing the toner T from scattering outside of the developing area A. At this time, for the toner scatter preventing member 27 to effectively prevent the toner T from scattering, the toner scatter preventing member 27 may be disposed as close to the photosensitive medium 31 as possible. A dimension of a gap between the photosensitive medium 31 and the toner scatter preventing member 27 may be 1.5 mm or less.

The toner scatter preventing member 27 may be rotatably supported by an inner frame 25 of the image forming apparatus 1. The inner frame 25 has a plurality of air holes 25a to help air to smoothly flow through. Therefore, a pressure inside a developing chamber (not illustrated) of the image forming apparatus where the developing unit 40c is disposed may be controlled. Also, a predetermined voltage 27a may be applied to the toner scatter preventing member 27, so that the toner scatter preventing member 27 can effectively prevent the toner T from scattering.

Referring to FIGS. 1 and 5, the transferring roller 60 is disposed to be in contact with the photosensitive medium 31 under the photosensitive medium 31, and transfers visible images developed by the developing unit 40 onto a printing medium entering between the photosensitive medium 31 and the transferring roller 60 from the printing medium feeding unit 10. A high voltage is applied to the transferring roller 60 from the power source 60a (see FIG. 5), so that the visible images formed on the photosensitive medium 31 are transferred onto the printing medium by an electrostatic force.

The fixing unit 70 fixes the visible images transferred onto the printing medium with the transferring roller 60 by using a high temperature and a high pressure. The fixing unit 70 includes a heating roller 71 generating a high heat and a pressure roller 72 applying a high pressure.

The remaining structure of the developing unit 40c according to this embodiment is substantially the same as the developing unit 40 of the previous embodiment described above with respect to FIG. 2, except for the toner scatter preventing member 27, and thus a detailed description thereof is omitted.

FIG. 6 is an enlarged sectional view illustrating another embodiment of a developing unit and a photosensitive unit used in an image forming apparatus 1 according to the present general inventive concept.

Referring to FIG. 6, a developing unit 40d according to this embodiment includes three developing rollers 51, 52 and 53 disposed inside the toner-conveying member 41. A first developing roller 51 is disposed near the photosensitive medium 31, a second developing roller 52 is disposed further away from the photosensitive medium 31, and a third developing roller 53 is disposed apart from the photosensitive medium 31 under the first developing roller 51. A gap between the third developing roller 53 and the photosensitive medium 31 may be substantially the same as a gap between the first developing roller 51 and the photosensitive medium 31. The first and third developing rollers 51 and 53 are driven rollers that guide the toner-conveying member 41 to follow an endless loop. The second developing roller 52 is a driving roller to rotate the toner-conveying member 41. The second developing roller 52 is substantially the same as the second developing roller 43 of the previous embodiment of FIG. 2, thus a detailed description thereof is omitted. The first and third developing rollers 51 and 53 have features substantially similar to the first developing roller 42 of the developing unit 40 according to the previous embodiment described above with respect to FIG. 2. The first and third developing rollers 51 and 53 may be disposed to be opposite to the photosensitive medium 31 so as to increase an area of the toner-conveying member 41 which faces the photosensitive medium 31. When the area of the toner-conveying member 41 which faces the photosensitive medium 31 is wider, a developing efficiency at which the toner T develops electrostatic latent images on the photosensitive medium 31 is increased.

The remaining structure of the developing unit 40d according to this embodiment is substantially the same as the developing unit 40 of the previous embodiment described above with respect to FIG. 2 except for the first, second, and third developing rollers 51, 52, and 53 disposed inside the toner-conveying member 41, thus a detailed description thereof is omitted.

The discharging unit 80 discharges the printing medium having the images fixed thereon through the fixing unit 70 and passes the printing medium to an outside of the image forming apparatus 1.

Hereinafter, an operation of an image forming apparatus 1 according to an embodiment of the present general inventive concept will be described with reference to FIGS. 1 and 2.

Upon receiving a printing order, the image forming apparatus 1 operates the pickup roller 13 of the printing medium feeding unit 10 to pick up a printing medium. A plurality of transmitting rollers 15 feeds the picked up printing medium to an area between the photosensitive medium 31 and the transferring roller 60. At the same time, the exposure unit 50 scans a laser beam to form electrostatic latent images corresponding to printing data on the photosensitive medium 31.

Due to continued rotation of the photosensitive medium 31, the electrostatic latent images enter the developing area A so as to face the developing unit 40. When the electrostatic latent images enter the developing area A, the toner T being conveyed by the toner-conveying member 41 of the developing unit 40 moves onto the photosensitive medium 31 to develop the electrostatic latent images into visible images.

Hereinafter, a process in which the developing unit 40 conveys the toner T will be described in detail.

When the second developing roller 43 and the supplying roller 45 rotate, the toner T held in the toner receptacle 47 moves along on a surface of the toner-conveying member 41 to the doctor blade 46. When the toner T on the surface of the toner-conveying member 41 passes underneath the doctor blade 46, the toner T is regulated into a thin toner layer. At this time, the second developing roller 43 has a lower hardness, so that a stress of the toner T due to a pressure between the second developing roller 43 and the doctor blade 46 is decreased to less than that of the conventional developing unit using a developing roller having a high hardness. In other words, when the toner T is regulated into a thin toner layer by the doctor blade 46, a stress that the toner T receives is minimized. As a result, a life span of the toner T may be prolonged. Also, when the toner T passes between the second developing roller 43 and the doctor blade 46 with the toner-conveying member 41, the toner T is charged by a friction force of the doctor blade 46. At this time, because the toner-conveying member 41 is supported to follow an endless loop by the first and second developing rollers 42 and 43, a rotation of the second developing roller 43 causes the toner-conveying member 41 to follow an endless loop.

When the toner-conveying member 41 moves, the toner T of the thin layer moves into the developing area A with the toner-conveying member 41. The toner T of the toner layer entering the developing area A moves onto the photosensitive medium 31 by an electrostatic force operating between the photosensitive medium 31 and the first developing roller 42, and develops the electrostatic latent images. At this time, because the first developing roller 42 supporting movement of the toner-conveying member 41 is supported by the first image forming part 32 supporting the photosensitive medium 31 and being separated from the second image forming part 49 supporting the developing unit 40, although driving the second developing roller 43, the supplying roller 45, and the agitator 48 which conveys the toner T to the developing area A causes the developing unit 40 to slightly move or/and shake, the first developing roller 42 is not moved due to movement of the developing unit 40. As a result, during printing, the developing gap G between the photosensitive medium 31 and the toner-conveying member 41 is constantly maintained.

On the other hand, as illustrated in FIG. 4, when the first developing roller 42 is elastically supported toward the photosensitive medium 31 by the pressing member 33 and the toner receptacle 47 is elastically supported in a direction opposite to the photosensitive medium 31 by the elastic member 23, the toner-conveying member 41 which follows an endless loop along the first and second developing rollers 42 and 43 may maintain itself tightly and convey the toner T even though some forces are applied to the developing unit 40. Therefore, there are not occurred image deficiencies such as jitter or images missing error caused by a variation of the developing gap G between the toner-conveying member 41 and the photosensitive medium 31.

Referring to FIG. 5, when the toner T moves from the toner-conveying member 41 to the photosensitive medium 31, some toner having weak charge may be scattered below the developing area A. The scattered toner may be returned into the developing area A by the toner scatter preventing member 27 disposed below the developing area A, and then, moves to the electrostatic latent images. At this time, the toner scatter preventing member 27 rotates in the same direction as the rotation direction of the photosensitive medium 31 and generates an upward air current between the photosensitive medium 31 and the toner scatter preventing member 27, so that the upward air current returns the scattered toner to the developing area A. Therefore, the image forming apparatus 1 according to an embodiment of the present general inventive concept can prevent a toner scattering that occurs in a non-contact type image forming apparatus.

While the photosensitive medium 31 continues to rotate, the visible images developed by the toner T are transferred onto a printing medium entering between the photosensitive medium 31 and the transferring roller 60. At this time, the toner T forming the visible images is moved from the photosensitive medium 31 onto the printing medium by the voltage applied to the transferring roller 60 so as to form images on the printing medium.

The printing medium having images transferred is moved to the fixing unit 70. When the printing medium passes through the fixing unit 70, a high temperature and a high pressure fix the transferred images onto the printing medium. After fixing, the printing medium is discharged through the discharging unit 80 out of the image forming apparatus 1, so that a printing is completed.

With an image forming apparatus according to the present general inventive concept, because the first developing roller causing the gap between the photosensitive medium and the toner-conveying member to be maintained constantly is disposed at the first fixing member separated from the developing unit, the first developing roller receives almost no effects caused by a distortion, a driving torque, etc. of the developing unit. Therefore, the image forming apparatus according to the present general inventive concept can maintain the gap between the photosensitive medium and the toner-conveying member constantly and uniformly during printing.

Furthermore, with an image forming apparatus according to the present general inventive concept, when regulating toner into a thin layer, stress of the toner may be minimized. Therefore, a life span of the toner may be prolonged.

Also, an image forming apparatus according to the present general inventive concept can prevent toner from scattering out of the developing area, and can naturally control an atmospheric pressure of a location where the developing unit is disposed. Therefore, it does not need a sensor to measure the atmospheric pressure therein.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus comprising:
a photosensitive medium on which electrostatic latent images are formed; and
a toner-conveying member configured to follow an endless loop apart from the photosensitive medium to convey toner to the photosensitive medium.

2. The image forming apparatus according to claim 1, further comprising:
a doctor blade to regulate the toner conveyed by the toner-conveying member into a thin toner layer and to charge the toner.

3. The image forming apparatus according to claim 2, further comprising:
at least two developing rollers disposed inside the toner-conveying member to drive and support the toner-conveying member to follow an endless loop.

4. The image forming apparatus according to claim 3, wherein the at least two developing rollers comprise:
a first developing roller disposed nearby the photosensitive medium; and
a second developing roller disposed underneath a part of the toner-conveying member in contact with the doctor blade to drive the toner-conveying member.

5. The image forming apparatus according to claim 4, further comprising:
a power source to apply voltage to at least one of the at least two developing rollers.

6. The image forming apparatus according to claim 4, wherein the second developing roller has a hardness to minimize a stress of the toner when the doctor blade regulates the toner into a thin layer.

7. The image forming apparatus according to claim 4, wherein the first developing roller further comprises:
a pair of gap rings having an outer diameter larger than an outer diameter of the first developing roller and disposed coaxially at both ends of the first developing roller.

8. The image forming apparatus according to claim 7, further comprising:
a pressing member to pull the first developing roller to the photosensitive medium in order that the pair of gap rings continue to be in contact with the photosensitive medium.

9. The image forming apparatus according to claim 4, further comprising:
a toner receptacle to hold the toner, at which the second developing roller and the doctor blade are disposed; and
a supplying roller disposed to be in contact with the toner-conveying member inside the toner receptacle to supply the toner held in the toner receptacle to the toner-conveying member.

10. The image forming apparatus according to claim 9, further comprising:
an elastic member to elastically support the toner receptacle in a direction opposite to the photosensitive medium.

11. The image forming apparatus according to claim 4, further comprising:
a pair of gap rings having an outer diameter larger than an outer diameter of the first developing roller and disposed coaxially at both ends of the first developing roller;
a pressing member to press the first developing roller to the photosensitive medium in order that the pair of gap rings continue to be in contact with the photosensitive medium; and
an elastic member to elastically support the toner receptacle, at which the second developing roller is disposed, in a direction opposite to the photosensitive medium.

12. The image forming apparatus according to claim 3, wherein the at least two developing rollers comprise:
a first developing roller disposed nearby the photosensitive medium;
a second developing roller disposed underneath a part of the toner-conveying member in contact with the doctor blade to drive the toner-conveying member; and
a third developing roller disposed apart from the photosensitive medium under the first developing roller by the same gap as a gap between the first developing roller and the photosensitive medium.

13. The image forming apparatus according to claim 1, further comprising:
a toner scatter preventing member disposed under a developing area between the photosensitive medium and the toner-conveying member apart from the photosensitive medium to rotate in a same direction as a rotation direction of the photosensitive medium.

14. The image forming apparatus according to claim 13, wherein a gap between the toner scatter preventing member and the photosensitive medium is 1.5 mm or less.

15. The image forming apparatus according to claim 13, wherein the toner scatter preventing member is rotatably disposed at an inner frame, and the inner frame has a plurality of air holes.

16. An image forming apparatus comprising:
a first image forming part comprising:
a photosensitive medium on which electrostatic latent images are formed,
toner-conveying member configured to follow an endless loop at a predetermined distance apart from the photosensitive medium to convey toner to the photosensitive medium, and
a first developing roller disposed a predetermined distance from the photosensitive medium to support the toner-conveying member; and
a second image forming part comprising:
a second developing roller to drive and support the toner-conveying member, and
a developing unit to provide toner to the toner-conveying member such that the toner transfers from the toner-conveying member to the photosensitive medium at the predetermined distance.

17. The image forming apparatus according to claim 16, further comprising:
a doctor blade to regulate the toner conveyed by the toner-conveying member into a thin toner layer,
wherein the first developing roller is disposed near the photosensitive medium and the second developing roller is disposed underneath a part of the toner-conveying member in contact with the doctor blade to drive the toner-conveying member.

18. The image forming apparatus according to claim 17, wherein the doctor blade charges the toner.

19. The image forming apparatus according to claim 16, wherein the first developing roller comprises a hard material having a high hardness and the second developing roller comprises a soft material having a low hardness.

20. The image forming apparatus according to claim 19, wherein the first developing roller comprises stainless steel (SUS), metal alloy (SUM), or aluminum (Al) and has a JIS-A hardness greater than or equal to 50.

21. The image forming apparatus according to claim 20, wherein the second developing roller comprises a material having a JIS-A hardness less than or equal to 50.

22. The image forming apparatus according to claim 16, wherein the first and second developing rollers are disposed inside the toner-conveying member, the first developing roller is disposed near the photosensitive medium, and the second developing roller is disposed underneath a part of the toner-conveying member.

23. The image forming apparatus according to claim 16, wherein the toner-conveying member further comprises a film.

24. The image forming apparatus according to claim 16, wherein the first developing roller is driven by the toner-conveying member.

25. The image forming apparatus according to claim 16, wherein the first developing roller comprises a fixed roller and when the second developing roller is driven to rotate the toner-conveying member, the toner-conveying member rotates and slides along a surface of the first developing roller.

26. The image forming apparatus according to claim 16, wherein the first developing roller further comprises:
a pair of gap rings having an outer diameter larger than an outer diameter of the first developing roller and disposed coaxially at both ends of the first developing roller to control the predetermined distance between the first developing roller and the photosensitive medium.

27. The image forming apparatus according to claim 26, wherein the outside diameter of the gap rings D is determined by the formula.
D=(R1+T+G)×2,
wherein R1 is a radius of the first developing roller, T is a thickness of the toner-conveying member, and G is a size of the predetermined distance.

28. The image forming apparatus according to claim 19, wherein the first developing roller comprises a material having a hardness high enough to uniformly control the predetermined distance in a direction parallel to a lengthwise direction of the first developing roller.

29. The image forming apparatus according to claim 16, wherein the second image forming part further comprises a supplying roller to supply toner to the toner-conveying member.

30. A method of forming an image with an image forming apparatus, the method comprising:
supplying toner from a developing unit to a toner-conveying member which surrounds first and second rollers in an endless loop;
conveying toner to a photosensitive member via the toner-conveying member;
driving the toner-conveying member with the second roller and supporting the toner-conveying member a predetermined distance from the photosensitive member with the first roller such that the toner-conveying member is supported by the first and second rollers.

31. The image forming method of claim 30, further comprising:
maintaining uniformity of the predetermined distance by selecting a material of the first roller to have a high hardness.

32. The image forming method of claim 30, wherein the maintenance of the uniform predetermined distance further comprises:
supporting the first roller and the photosensitive member in a first image forming part of the image forming apparatus; and
supporting the second roller and the developing unit in a second image forming part of the image forming apparatus,
wherein the first image forming part is isolated from movement of the second image forming part.

33. The image forming method of claim 32, wherein the maintenance of the uniform predetermined distance further comprises:
elastically supporting the first roller toward the photosensitive member in the first image forming part; and
elastically supporting the developing unit in a direction opposite to the photosensitive member.
